(19) United States
(12) Patent Application Publication
(10) Pub. No.: US 2008/0016066 A1
(43) Pub. Date: Jan. 17, 2008

(54) ADAPTIVE INDEX WITH VARIABLE COMPRESSION

(75) Inventors: Tsia Kuznetsov, Cupertino, CA (US); ILYA M. SANDLER, Cupertino, CA (US)

Correspondence Address: FLIESLER MEYER LLP, 650 CALIFORNIA STREET, 14TH FLOOR, SAN FRANCISCO, CA, 94108, US

(73) Assignee: Tele Atlas North America, Inc., Lebanon, NH (US)

(21) Appl. No.: 11/770,058

(22) Filed: Jun. 28, 2007

Related U.S. Application Data
(60) Provisional application No. 60/806,366, filed on Jun. 30, 2006.
(60) Provisional application No. 60/806,367, filed on Jun. 30, 2006.

(51) Int. Cl. G06F 17/30

(52) U.S. Cl. 707/6; 707/E17.012; 707/E17.018; 707/E17.039

(57) ABSTRACT

Present invention builds on the trie concept to construct a system for compact indexing and efficient multi-dimensional searching of objects using a flexible composition of a string search key and other search criteria, to facilitate fast prototyping of compressed object store and search trees, which embody a variety of search methods.

### CLAIM OF PRIORITY

This application claims priority from the following co-pending applications, which are hereby incorporated in their entirety: U.S. Provisional Application No. 60/806,366 entitled: “ADAPTIVE INDEX WITH VARIABLE COMPRESSION”, by Tsia Kuznetsov, et al., filed Jun. 30, 2006, (Attorney Docket No. TELA-07780US0) and U.S. Provisional Application No. 60/806,367 entitled: “NEAREST SEARCH ON ADAPTIVE INDEX WITH VARIABLE COMPRESSION”, by Tsia Kuznetsov, filed Jun. 30, 2006, (Attorney Docket No. TELA-07781US0).

### BACKGROUND OF INVENTION

A number of applications can use stored geographic data to provide mapping services for a user. The applications that can be implemented for mobile or stationary systems can include map rendering, spatial object search, geocoding or geo-lookup, path search, direction and positioning. Object search, particularly object search by a string key, can be used for these applications.

### BRIEF DESCRIPTION OF THE DRAWINGS

FIG. 1 shows a map-based system of one embodiment of the present invention.

FIGS. 2A-2B shows systems with and without indexing.

FIGS. 3A-3B shows a short leaf node and a long leaf node.

FIGS. 4A-4B shows a tree system of one embodiment.

FIG. 5 is a flowchart of a method of one embodiment.

FIGS. 6A-6C illustrates the operation of embodiments of the method of FIG. 5.

FIG. 7 illustrates an example where nodes contain indications of other search criteria, such as exclusion or inclusion information.

FIG. 8 illustrates the use of a single object store with multiple trees.

FIG. 9A-9B illustrates the use of an API to select a key structure for the tree.

### DETAILED DESCRIPTION

One embodiment of the present invention is a computer-implemented method for adaptive construction of a search system for searching objects by their string key. The search system can include objects that reside in the object store 108, and the tree 102 that can be constructed using the objects with their string key structure.

The tree 102 can be based on a trie, or prefix tree, which is an ordered tree data structure that is used to index objects where the keys are strings that accommodate a specific search method. The trie facilitates retrieval of the choice of next characters, given a partial string key input. A description of tries is given in Donald Knuth. The Art of Computer Programming, Volume 3: Sorting and Searching, Third Edition. Addison-Wesley, 1997. ISBN 0-201-89685-0. Section 6.3: Digital Searching, pp. 492-512.

The trie can be reconstructed to be adaptable to restrictive storage requirements through a serious of steps that manipulate key prefixes and minimize the number of nodes and leaves. In one embodiment, most leaf nodes of the tree 102 can be associated with multiple objects in the object store, which can mean that only a portion of the full key is searched in the tree before obtaining a group of objects from the object store. For example, the tree 102 can be a variable-scale compression of a full trie.

Tree storage can be minimized based on a given compression criteria. An adaptable search method can be used to retrieve objects via the search tree and said object store. The search can adapt to the tree structure resulting from compression and a given user interface.

In one embodiment, the object store 108 models spatial objects in the real world that can be searched using a string key. The real world spatial objects can include cities, streets in the city, intersections, points of interests (POIs), or another type of object that can be associated with a string key.

In one embodiment, objects can be stored in the leaves of the trie. In another embodiment, to accommodate multiple search methods on the same set of objects, a separate object store can be constructed for a given type of object as either fixed length or variable length storage. Storage for variable length objects can be constructed with a fixed length object offset directory. Such an object store can accommodate search and scrolling of objects.

The object store entries can be determined by the unique key of each object, wherein the order of objects in the store can be determined by the object's sorting key. The object store can distinguish between components of the search key

In one embodiment, once the object store is set up, the search tree 102 can be constructed such that the reference to each object in the store can be found in a tree leaf using object's search key.

The search key structure of the tree can indicate spatial objects, such as streets, street intersections, Points of Interest (POIs) or other elements or attributes of objects. In one embodiment, the order by which components of the key for a given class of objects are concatenated indicates specific search method for this class of objects. The order of concatenation of the key components can be the simple mechanism by which the system designer can rapidly prototype and experiment with various user interfaces embodied in a multitude of string key definitions for a given class of objects.

An API can be implemented and used in an application to aid in the construction of the search key and thus the search method, to allow designers to produce and experiment with a variety of user interfaces for the search of an object. In one embodiment, a GUI can be built using such API to define and select a key structure(s) for the search method(s) on a given class of objects, whereby imposing an appropriate order on the object store and tree(s). The API can give system designers the flexibility to change a search system's interface with ease typically associated with the RDBMS technology, without relying on a relational database management system, which may have impractical storage requirements for some environments.

Thus by selecting the string key components and the component order for a composition of the key structure, a designer can assess a variety of user interfaces and underlying search methods.

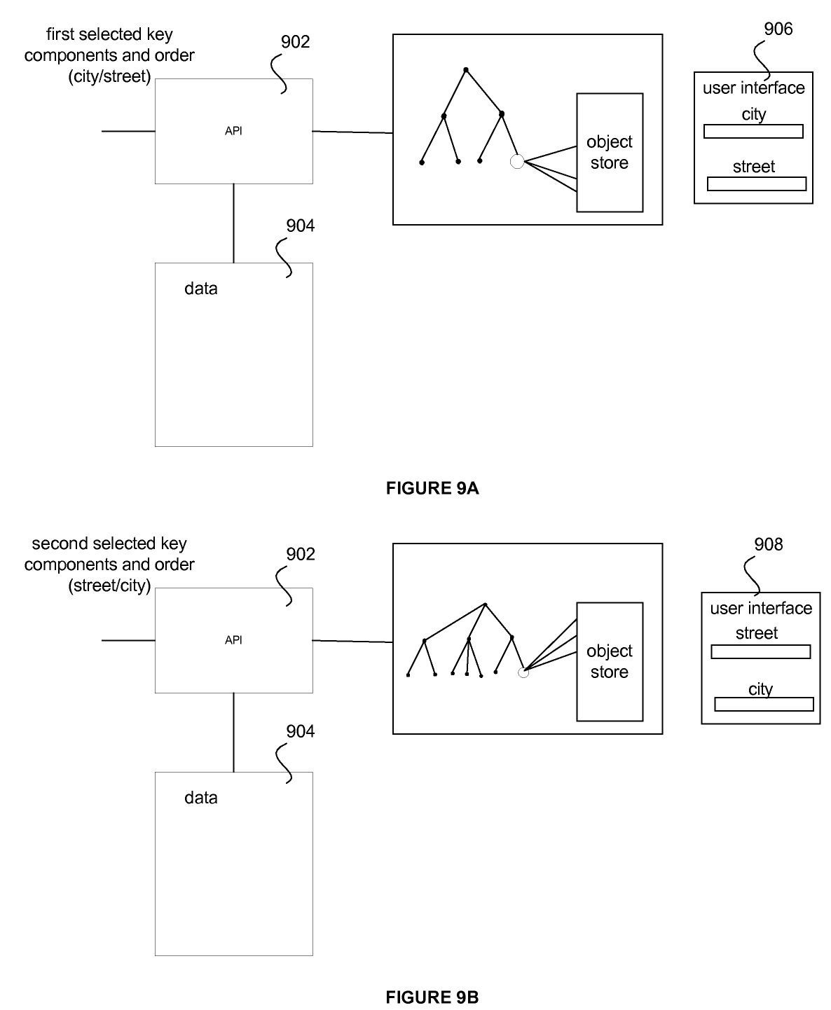

FIGS. 9A and 9B show the construction of trees and object stores using an API 902. A designer can select key components and order from the data 904. For example, data fields of the data 904 can be used as key components. The key structure and the data can be used to construct a tree and object store that can be accessed via a user interface, which implements a search method expressed in the key structure.

FIG. 9A shows an example where the key structure is given by CITY/STREET. This means that the user interface 906 is adapted to receive data in this order. FIG. 9B shows an example when the key structure is given by STREET/CITY with the user interface 908 adapted to receive data in this order.

For a given user interface profile and a chosen compression criteria, a score can be generated for search tree size, object store size, memory requirements, and best and worst case search performance. This can give system designer a tool to balance various requirements by comparing scores of different implementations.

For example, the amount of compression can affect the performance of the system. High levels of compression can mean that more objects need to be obtained from the object store and analyzed. Low levels of compression can result in large storage requirements for the tree. The variable compression criteria that regulate tree construction and can maximize number of objects referenced by a leaf node can be tuned to reasonably balance performance, memory and storage use for the ultimate application. In one embodiment, compression criteria regulate a minimum number of objects under any branch of the tree.

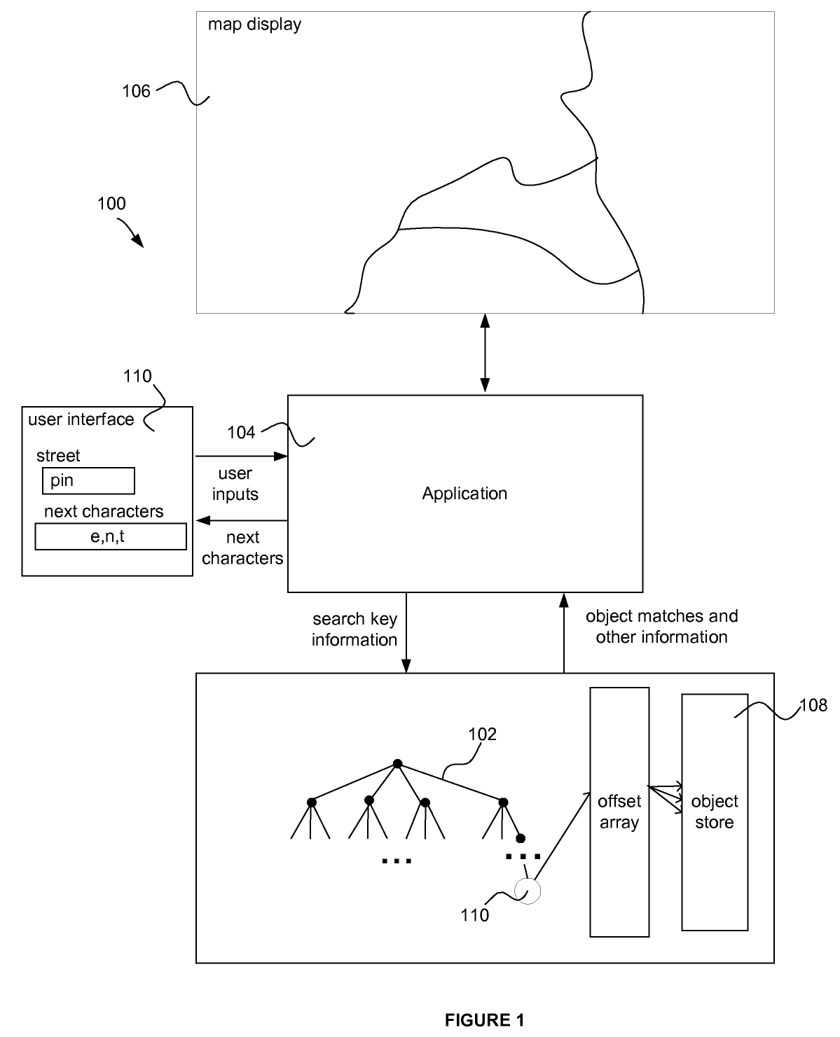

Looking again at FIG. 1, the tree can include leaf nodes that reference multiple objects in an object store 108 as the result of variable compression. The objects or object references in a leaf node can have different key values, with the common prefix matching that of a leaf's parent node. This can mean a more complex search algorithm that augments a partial search on the tree with following the object references to the object store to complete the search, as opposed to the straight forward search on the original non-compressed trie structure,

The leaf nodes can be distinguished as a short leaf node or a long leaf node. A short leaf references a first object in the contiguous list, and a number of objects referenced. A long leaf can reference an arbitrary list of objects by storing a count of references, and a direct reference for each object in the list. The search can include finding a leaf node 110 based on a search key and locating a set of matches among the objects referenced by the leaf node.

In one embodiment, a user inputs a search string character by character and the application searches the tree 102 to indicate a set of valid next input characters, until the search string is complete or the user requests a set of objects that match a partial key. The application can provide a display indicating the valid next characters, or otherwise output the valid next characters. In another embodiment, a user inputs an entire or a partial search string. The tree that supports such searches can store the key prefix string at each tree node, with the shortest at the root and the full search key at the leaf. In one embodiment of the present invention, the search tree is compressed by reducing the node's key prefix to store only its own extension of the parent's prefix, such that the actual key prefix of a node is obtained by concatenating all key prefix strings on the path from the root to this node with the node's stored key prefix. In one embodiment of the adaptive index, the search tree is further compressed by collapsing nodes with a single child.

One embodiment of the present invention is a system comprising an application 104 with a map display 106 and a search system including a tree 102 and the object store 108. The Tree 102 can be constructed with nodes associated with a key structure. The tree 102 can be compressed by reducing each node's prefix. The tree 102 can include leaf nodes that store objects, when the class of objects is intended to be accessed via a single search method. The tree 102 can include leaf nodes that contain references to objects in the object store, when that class of objects is intended to be accessed via more than one search method. The tree 102 can include leaf nodes that reference multiple objects in an object store 108, as the result of variable compression. The search can include searching to find a leaf node 110 based on a search key and checking the objects indicated by the leaf node.

The system 100 can have a user interface 110 that can receive input from the user and produce an output. One exemplary output can be next character indication that shows the valid next characters. The set of available next characters can be determined from a search of the tree 102 and/or object store 108 as discussed below.

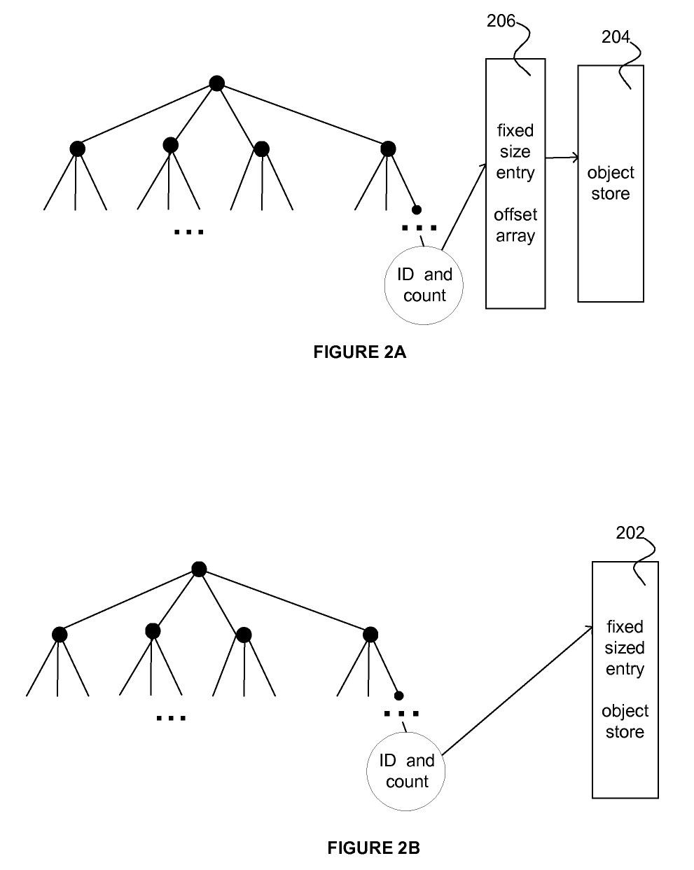

FIGS. 2A and 2B shows examples of short leaf nodes that contain a pointer (ID) to the first object and a number of objects that can be retrieved from an object store with a minimum number of read operations. FIG. 2A shows an example where objects are stored in an object store 202 with fixed sized entries, requiring a single read (provided there is sufficient memory.) FIG. 2B shows an example where objects are stored in an object store 204 with variable sized entries. In that case, an offset array 206 with fixed sized offsets can be used to limit the number of read operations to two (provided there is sufficient memory.)

In both cases, object data can be obtained corresponding to the number of counts. For example, if the count is 50, the next 50 objects can be obtained from the object store and analyzed as appropriate. Short leaf nodes reduce storage requirements for the tree. This can be valuable for mobile geographic applications implemented on resource-constrained systems.

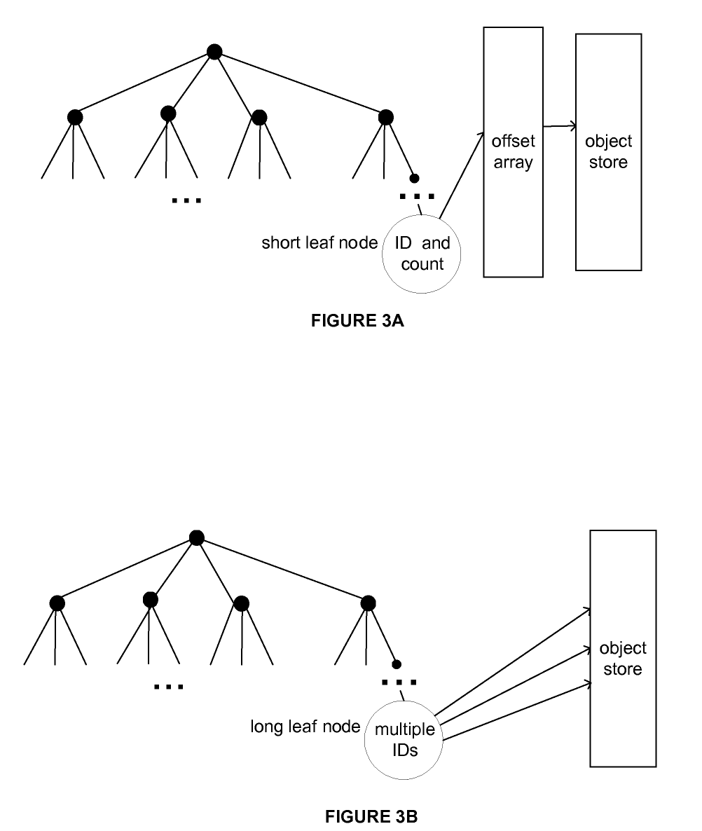

In one embodiment, consecutive objects can be stored in a short leaf as shown in FIG. 3A. The short leaf node can contain an ID and a count. The order of the objects in the object store is arranged in the order indicated by the key structure.

FIG. 3B shows a long leaf. The long leaf can be used to point to non-consecutive objects with individual pointers for each object.

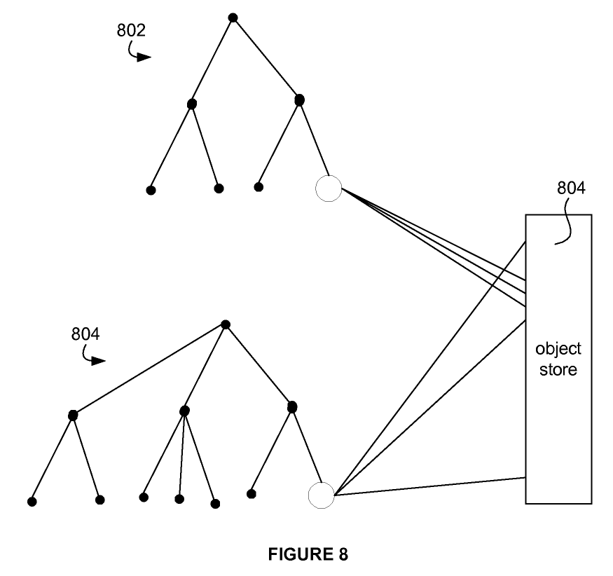

FIG. 8 shows an example with two trees 802 and 804 pointing to objects in the same object store 806. The two trees can be associated with two different input elements in a user interface. Typically, the tree whose search key structure follows the order of objects in the store 806 can use short leaf nodes to point to consecutive objects. The other trees can use long leaf nodes. Long leaves increase storage requirements. Number of read operations on long leaf objects is proportional to the number of objects in a long leaf.

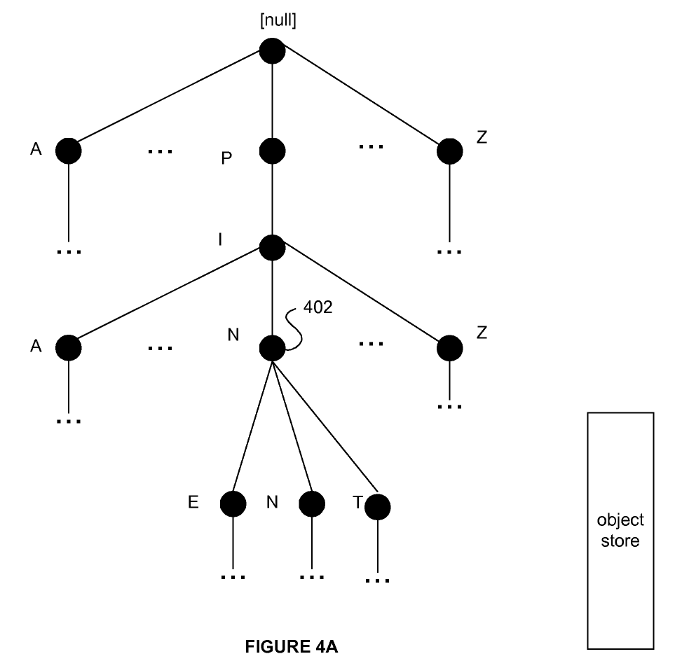

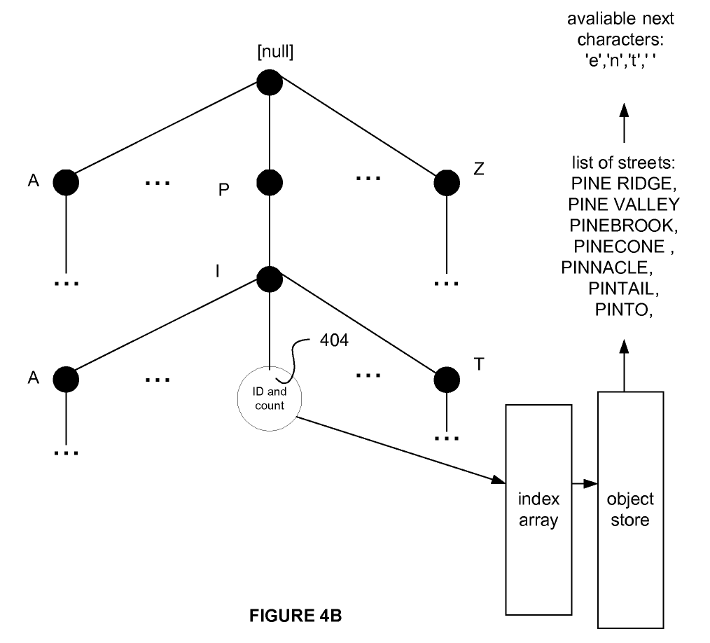

FIG. 4A illustrates an example of how to get the set of “next available character” in one embodiment. If a user has input “PIN”, the next available characters can be obtained by checking the prefixes of children nodes for node 402.

FIG. 4B shows a system where a leaf node 404 references multiple consecutive objects in the object store. In this example, the names of objects corresponding to node 404 are obtained from the object store and analyzed to get the “next character” information. In the example of FIG. 4B, the names PINE RIDGE, PINE VALLEY, PINEBROOK, PINECONE, PINNACLE, PINTAIL, PINTO of objects associated with leaf node 404 all start with the user input “PIN”. These names can be analyzed to obtain the valid next characters {“,‘E’,‘N’,‘T’}, which can be output to the user. Scrolling and other functions can be implemented in a similar manner with groups of object data associated with leaf nodes being obtained and then processed for display.

In one embodiment the leaf nodes need not have associated key information. This can mean that the leaf nodes will have the same key prefix as their parent node. This can allow the objects or object references to be easily combined into leaf nodes for most efficient packing.

In one embodiment, the objects referenced by the leaf node can be accessed then analyzed to determine the next character and to implement scrolling. The tree can have the leaf nodes at different levels of the tree.

One embodiment of the present invention is a computer-implemented method of constructing a tree comprising a list of keys following a key structure, constructing a full tree structure and then pruning it, by combining nodes such that most leaf nodes are associated with multiple objects.

Compression techniques can include maximizing leaf node references to objects to minimize storage overhead required for each node, based on a given criteria.

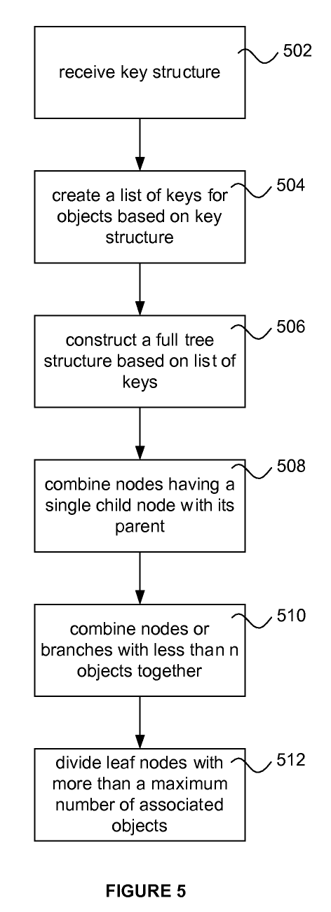

FIG. 5 shows an exemplary flowchart of one embodiment. In step 502, a key structure is determined. An exemplary key structure for street name can be “street name?city-name” where “‘?’” Is a delimiting character. For example, “Kensington?San Francisco”. An exemplary key structure for Intersection may be “street1name?street2name?city-name”. Objects can be duplicated in the object store so that either order can be used to search for streets intersections. For example, “Oak?Elm?Sacramento” and “Elm?Oak?Sacramento” can represent two different tree search paths that lead to a single entry, or to two entries of the tree object store, each referencing the same real intersection with its set of attributes.

In step 504, a list of keys for the objects based on the key structure can be determined. The key structure can also determine the order of the objects in the object store.

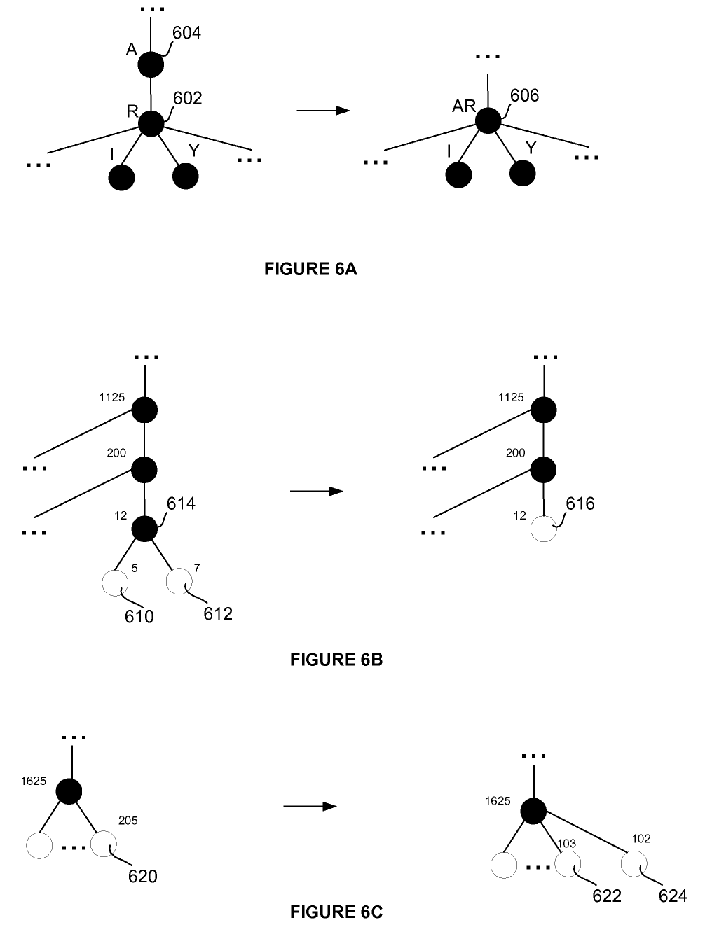

In step 506, a full node structure can be created based on the list of keys. This full node structure can be compressed as shown in steps 508, 510 and 512 to reduce the size of the tree by reducing the number of nodes and leaves. Exemplary steps are also shown in FIGS. 6A-6C.

In FIG. 6A, node 604 with a single child node 602 is combined with the child node 602 to form node 606. Node 606 is associated with multiple characters in the search string.

FIG. 6B shows an example of a compressing step. In the example of FIG. 6B, each grandchild node is checked to see whether it can be combined with another grandchild node. In one example, if both grandchild nodes have less than a given number of associated objects (such as 16 in one implementation), the tree is pruned to accommodate this criteria. In the example of FIG. 6B, nodes 610, 612 and 614 are combined together to form node 616.

FIG. 6C shows a case where node 620 is split into nodes 622 and 624 to keep the number of objects associated in each leaf node below a maximum size (such as 63 in one embodiment).

The above example shows the steps as distinct. In another embodiment, the compression steps can be combined into a single step producing the same results.

In one embodiment, tree nodes can store indications of other search criteria. A search or other operation on the tree can use the indications to determine whether the node and its offspring nodes or associated objects need to be further analyzed. In one embodiment, the indications can be used to implement an n-dimensional search

In one embodiment, the searches can be filtered by object attributes such as a category or a city. The indications can include indications of object categories that are not found among the node's offspring and/or indications of object categories that are included in at least one of its offspring. Similarly, if indications include city id, the searches can be filtered by a city. In one embodiment, a user can search a point of interest by name, refined by a specified object category, and further refined by the name of the city where it resides.

For example, if the presence or absence of points of interest categories is indicated on a tree node, a character search for a point of interest could eliminate from the search path the nodes that exclude a category, such as fast food.

In one embodiment, the nodes can store category exclusion or inclusion information to simplify and speed up a search for a specific category. The exclusion information can indicate that no object associated with the node is in the category. The inclusion information can indicate that there is an object associated with the node in the category.

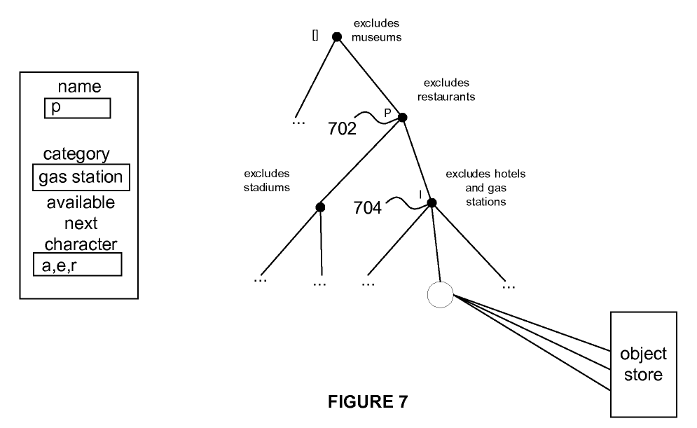

FIG. 7 shows one example. In this example, a search on the tree segment can stop at node 702 if the search is for a restaurant and at node 704 if the search is for a gas station. The indications of other search criteria, such as exclusion information, can be implemented at the time of creation of the node tree.

The tree of FIG. 7 can be used for a multi-dimensional search. For example, the key information can be checked for a first dimension of the search and the search criteria information can be checked for additional dimensions of the search.

In one example, the user interface can include checkboxes or the like to receive user input for additional search criteria indicated on the tree, for example object categories. The search can use the category information to determine which nodes to examine in the search. In the example of FIG. 7, if the user was looking for a gas station and had input a “P”, “I” would not be shown as a next available character because node 704 excludes gas stations.

The search criteria can be a code associated with certain nodes to indicate the categories not found among the node's offspring or the like. The objects in the object store can also have associated category information so the two dimensional search can involve both the nodes of the tree and the objects in the object store.

The API used to select the key structure can be used to add additional search criteria to the tree to enable the multi-dimensional search.

As described in the co-pending U.S. Patent Application, NEAREST SEARCH ON ADAPTIVE INDEX WITH VARIABLE COMPRESSION, Ser. No. 60/806,367, (corresponding to attorney docket number TELA-07781US0), the search system can be used to do a nearest search to a specific position.

One embodiment may be implemented using a conventional general purpose of a specialized digital computer or microprocessor(s) programmed according to the teachings of the present disclosure, as will be apparent to those skilled in the computer art. Appropriate software coding can readily be prepared by skilled programmers based on the teachings of the present discloser, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A computer-implemented method comprising;
searching a tree, the tree being constructed with nodes associated with a key, the tree being pruned according to the given compression criteria, the tree including leaf nodes storing multiple objects or referencing multiple objects in an object store, the multiple objects having different key values, the search including searching to find a leaf node based on a search key; wherein the search further comprises checking the objects indicated by the leaf node.

2. The computer-implemented method of claim 1, wherein the leaf nodes are associated with the same key prefixes as their parent nodes.

3. The computer-implemented method of claim 1, wherein nodes store indications of other search criteria.

4. The computer-implemented method of claim 3, wherein the indications of other search criteria include indications of object attributes that are not found among the node's offspring.

5. The computer-implemented method of claim 3, wherein the indications of other search criteria include indications of object attributes that are included in at least one offspring of the node.

6. The computer-implemented method of claim 1, wherein an API is used to select a key structure for the search system and in response to the selection of the key structure, keys of objects are used to construct the object store and tree.

7. The computer-implemented method of claim 1, wherein a user inputs a key to an application character by character, the application searching the tree to indicate valid next input characters.

8. The computer-implemented method of claim 7, wherein the application provides an output indicating the valid next characters.

9. The computer-implemented method of claim 1, wherein the key structure indicates a geographic locality or object's name.

10. The computer-implemented method of claim 1, wherein the key structure indicates states and cities.

11. The computer-implemented method of claim 1, wherein the key structure indicates streets.

12. The computer-implemented method of claim 1, wherein the key structure indicates street intersections.

13. The computer-implemented method of claim 1, wherein the key structures indicates Points of Interest.

14. The computer-implemented method of claim 1, wherein the key structure indicates coordinates.

15. The computer-implemented method of claim 1, wherein the key structure indicates objects linked to locations.

16. The computer-implemented method of claim 1, wherein the leaf nodes indicate multiple objects with the same prefix inherited from the leaf's parent.

17. The computer-implemented method of claim 1, wherein the search is done for object names.

18. The computer-implemented method of claim 1, wherein the search is done for geo-coding, geo-lookup, reverse geocoding, and Points of Interest.

19. A system comprising;
an application and;
a search system to search a tree for the application, the tree being constructed with nodes associated with a key, the tree including leaf nodes associated with multiple objects in an object store, the multiple object having different key values, the search including searching to find a leaf node based on a search key; wherein the search further comprises checking the objects indicated by the leaf node.

20. The system of claim 19, wherein nodes store indications of other search criteria.

21. The system of claim 20, wherein the indications of other search criteria include indications of object attributes that are not found among the node's offspring.

22. The system of claim 19, wherein the objects searched for are non-spatial objects.

23. The system of claim 20, wherein the indications of other search criteria include indications of object attributes that are included in at least one offspring of the node.

24. The system of claim 19, wherein the objects searched for are spatial objects.

25. The system of claim 19, wherein an API is used to select a key structure for the search system and in response to the selection of the key structure, keys of objects are used to construct the object store and tree.

26. The system of claim 19, wherein a user inputs data to an application, the application searching the tree to indicate valid next input characters.

27. The system of claim 25, wherein the application provides a display indicating the valid next characters.

28. The system of claim 19, wherein a portion of the key indicates a state.

29. The system of claim 19, wherein a portion of the key indicates a city.

30. The system of claim 19, wherein a portion of the key indicates a street.

31. The system of claim 19, wherein a portion of the key indicates a street intersection.

32. The map based system of claim 19, wherein the key structure indicates points of interest.

33. The map based system of claim 19, wherein the key structure indicates coordinates.

34. The map based system of claim 19, wherein the key structure indicates objects linked to spatial objects.

35. The map based system of claim 19, wherein the leaf nodes indicate multiple objects with the same prefix.

36. The map based system of claim 19, wherein the search is done for geo-coding.

37. The map based system of claim 19, wherein the search is done for geo-lookup.

38. The map based system of claim 19, wherein the search is done for reverse geocoding.

39. The map based system of claim 19, wherein the search is done to locate Points of Interest.

40. A computer-implemented method comprising;
searching a tree to determine available next characters, the tree being constructed with nodes associated with a key, the tree including leaf nodes associated with multiple objects in an object store, the multiple object having different key values, wherein the search to determine available next characters includes getting available next character information from the tree and/or from objects in the object store.

41. A computer-implemented method of constructing a tree structure comprising:
receiving a list of objects with keys following a key structure;
constructing a full tree structure; and
combining nodes such that most leaf nodes are associated with multiple objects.

42. The computer-implemented method of claim 41, wherein nodes store indications of other search criteria.

43. The computer-implemented method of claim 42, wherein the indications of other search criteria include indications of object attributes that are not found among the node's offspring.

44. The computer-implemented method of claim 42, wherein the indications of other search criteria include indications of object attributes that are included in at least one offspring of the node.

45. The computer-implemented method of claim 42, wherein an API is used to select a key structure for the search system and in response to the selection of the key structure, keys of objects are used to construct the object store and tree.

46. The computer-implemented method of claim 41, wherein the tree height is pruned according to the compression criteria.

47. The computer-implemented method of claim 41, wherein the combining steps includes combining leaf nodes.

48. The computer-implemented method of claim 41, wherein the objects referenced by short leaf nodes are stored contiguously.

49. The computer-implemented method of claim 41, wherein the objects referenced by long leaf nodes point to non-sequential objects.

50. A computer-implemented method comprising:
searching nodes of a tree, the nodes of tree indicating key information, at least some nodes indicating additional search criteria information, the search being multi-dimensional such that the key information is checked for a first dimension of the search and the search criteria information is checked for an additional dimensions of the search.

51. The system of claim 50, wherein the key values are compared to user input in the first dimension of the search.

52. The system of claim 50, wherein the pruned tree includes leaf nodes that store multiple objects or reference multiple objects in an object store.

53. The system of claim 50, wherein the search criteria indicate object attributes not found among the node's offspring.

54. The system of claim 50, wherein the search criteria indicate object attributes included in the node's offspring.

55. A computer-implemented system comprising;
a) a definition, for a class of objects, of string search key components that can be manipulated to accommodate a multitude of user interfaces;
b) an object store that distinguishes between components of a search key;
c) a composition of a search key structure from said components to yield a given user interface;
d) an adaptable search tree composed for a given search key definition where nodes are associated with a search key structure, the leave nodes store objects or reference objects in an object store, and the tree storage is minimized based on a given compression criteria, wherein an adaptable search method is used to locate matching objects via the search tree and said object store, the search adapting to the tree structure resulting from compression and a given user interface.

56. The computer implemented system of claim 55, where retrieval of matching objects from the said tree is based on an input of a partial or a full search key.

57. The computer implemented system of claim 55, where a search key is defined by selecting a full set or a subset of primary search key components.

58. The computer implemented system of claim 55, where a search key is defined by imposing an order on selected primary search key components.

59. The computer implemented system of claim 55, where the object store order is imposed by the primary search key.

60. The computer implemented system of claim 55, wherein one or more search trees, each with its own search key structure, can reference the same object store.

61. The computer implemented system of claim 55, where unique key structure is defined for a class of objects.

62. The computer implemented method of claim 55, wherein next available input characters can be retrieved from compressed tree and/or an object store.

63. The computer implemented system of claim 55, wherein for a given user interface profile and a chosen compression criteria, a score is generated for search tree size and best, average and worst case search performance, giving system designer a tool to balance various requirements by comparing scores of different implementations.

64. The computer implemented system of claim 55, accommodating multi-dimensional search by optionally storing at each tree node additional search criteria indicating presence of at least one object matching a given criterion among that node's offspring.

65. The computer implemented system of claim 55, wherein the compression includes combining and splitting nodes and branches.

66. The computer implemented system of claim 65, wherein the combining and splitting is done in a single step.

67. A computer implemented system for accommodating a variety of user interface look and feel profiles, comprising:
a) a definition, for a class of objects, of a string search key components that can be manipulated to accommodate a multitude of user interfaces;
b) an object store that distinguishes between components of a search key;
c) a composition of a search key structure from said components whereby manipulation of components of a key implement a different user interface;
d) an API to define a string key structure whereby a designer can select components of a key and an order of components in a key that results in a different user interface of the search; and
e) an adaptive compressed search tree to accommodate object search for one of a multitude of user interfaces that can be implemented from search key components in the object store, wherein nodes are associated with a search key structure, the leaves store objects or reference objects in an object store.
